(19) United States
(12) Patent Application Publication
(10) Pub. No.: US 2007/0051566 A1
(43) Pub. Date: Mar. 8, 2007

(54) Automatic brake control for hand-propelled vehicles

(76) Inventor: John Keith Marlow, GOLD COAST (AU)

Correspondence Address: SHOEMAKER AND MATTARE, LTD, 10 POST OFFICE ROAD - SUITE 110, SILVER SPRING, MD, 20910, US

(21) Appl. No.: 10/559,605

(22) PCT Filed: Jun. 4, 2004
(86) PCT No.: PCT/AU04/00740

§ 371 Date: Dec. 2, 2005

(30) Foreign Application Priority Data
Jun. 4, 2003 (AU) 2003902787

(51) Int. Cl. B62B 9/08

(52) U.S. Cl. 188/20

(57) ABSTRACT

Hand-propelled vehicle (10) such as a pram or stroller has electrically-operated brake apparatus (13) which is applied automatically on a user releasing their grip from handle (12). Braking does not occur immediately grip or touch sensors (17) on handle (12) register that the user has released handle (12). Programmable controller (19) is provided which only applies brake (13) if sensors (16) detect movement of vehicle (10) and/or that vehicle (10) has moved more than a set distance subsequent to release of handle (12). Therefore braking apparatus (13) acts as a safety feature that only applies if, say, a vehicle is released on a slope and movement due to the slope is detected.

### TECHNICAL FIELD

This invention relates to improvements to hand-propelled vehicles. The present invention has particular application to prams or strollers for carrying babies or infants however the invention may be applied to any other form of hand propelled vehicle.

### BACKGROUND ART

Hand-propelled vehicles of many different designs and configurations are known. Generally however, the vehicles are provided with a handle which is rearwardly disposed or rearwardly extending which can be grasped by the user so as to enable the vehicle to be propelled either forwardly or rearwardly and steered. Many hand-propelled vehicles do not have brakes which means that for safety purposes they cannot be left unattended particularly on sloping ground. In vehicles which do have brakes, the brake actuators for the brakes are either located adjacent the vehicle wheels such that actuation thereof is often awkward or alternatively brake actuators may be provided on the handle. A disadvantage of both these arrangements is that if the brakes are applied and the user without releasing the brakes tries to push the vehicle, the vehicle can tip forwardly which in the case of prams or strollers may cause injury to an infant in the pram or stroller. Some prams and strollers have braking systems which are automatically applied when the handle of the vehicle is released, the handle for this purpose having a separate or movable actuating portion. A disadvantage of these systems is that the brakes are always applied when the handle is released. This may not be desirable in many situations. In other systems, considerable gripping force is required to be applied to the movable handle portion to maintain the brakes in a released state which is inconvenient and tiring for the user.

### SUMMARY OF THE INVENTION

The present invention aims to provide braking apparatus for hand-propelled vehicles which overcomes or at least alleviates one or more of the above disadvantages. The present invention also aims to provide a hand-propelled vehicle having an improved braking apparatus. Other objects and advantages of the invention will become apparent form the following description.

The present invention thus provides in a preferred aspect, braking apparatus for use with a hand-propelled vehicle, said apparatus including means for sensing grip on, or touching of, portion of said vehicle by a user of said vehicle, and control means associated with said touch or grip sensing means for preventing or stopping movement of said vehicle after or upon a predetermined movement of said vehicle subsequent to release of said vehicle by said user as sensed by said touch or grip sensing means.

Preferably the touch or grip sensing means for sensing touching of or grip on the vehicle is associated with a handle of the vehicle by which the vehicle is normally propelled by hand. Suitably the touch or grip sensing means comprises one or more touch sensitive switches. The touch sensitive switches may comprise a touch pad or pads on or in the handle. Alternatively, the or each touch sensitive switches may comprise a pressure responsive switch or switches on or in the handle. For example, the switches may comprise fluid pressure responsive switches which are actuated upon increase of fluid pressure consequent upon gripping of the handle. The fluid pressure actuated switches may comprise pneumatic or liquid pressure actuated switches. Thus the control means will be able to sense whether the handle of the vehicle is being touched or grasped by a user and whether the handle is released. The control means suitably prevents or stops movement of the vehicle by means of actuation of a selectively actuable brake assembly associated with one or more wheels of the vehicle. The or each brake assembly may comprise a brake activation device and a braking member which is movable by the activation device into engagement with a vehicle wheel to prevent or stop rotation thereof. The braking member may comprise a brake pad or may comprise any form of movement inhibiting member which may be moved to a position to prevent wheel rotation. The activation device may also be selectively-actuable to release the braking member from the wheel to allow its rotation. Alternatively, the activation device may be single acting and associated with a mechanical member such as a spring which applies the braking force or releases the braking force in accordance with the state of activation of the brake activation device.

The activation device preferably comprises an electrically operated activation device and the control means is suitably arranged to control the supply of power to the brake activation device to control activation thereof. Preferably, the control means is associated with a switch which may be turned on or off by the control means to control supply of power to the brake activation device.

Power for activation of the brake activation device is suitably supplied by any form of power supply. Most preferably, the power supply comprises one or more batteries. The power supply also suitably supplies power to the control circuitry of the apparatus. Power supplied to the brake activation device may be varied to vary the braking action or the extent of braking provided by the brake member.

The switch controlled by the control means may comprise a switch associated with the touch or grip sensing means. The switch may be such as to ensure that the brakes are not applied when the touch or grip sensitive-means sense touch or grip of the handle of the vehicle. The switch or switches thus may be arranged such that power is not supplied to the brake activation device when at least the touch or grip sensitive means sense touching or gripping of the handle of the vehicle. Thus in normal operation in gripping the handle and pushing of the vehicle, the brakes are not applied. In a particularly preferred form, the touch or grip sensing means suitably may comprise a pair of grip or touch sensitive pads or switches which are spaced apart on the handle of the vehicle and both of which are required to be activated by touch or grip by both bands of a user to ensure the brakes are not applied in normal operation. Such an arrangement will prevent the vehicle being pushed by a small infant who would be unable to reach a pair of spaced pads or switches and may normally grip the handle of the vehicle with the hands located together.

Movement sensing means are also preferably associated with the vehicle for sensing the velocity of movement of the vehicle and/or directly or indirectly, the distance moved by the vehicle. Such means may be associated with a vehicle wheel to sense speed of rotation of the vehicle or actual rotation of the vehicle wheel to thereby indicate distance moved by the vehicle.

The control means is preferably associated with the movement sensing means whereby the control means can determine when, by activation of the brake activation device, to prevent or stop movement of the vehicle. The control means is suitably programmable control means which may be programmed to enable setting of the rotational speed or distance moved by the vehicle before activation of the brake activation device. The control means may include or comprise a programmable microprocessor.

In a further preferred arrangement, the touch sensitive pads or switches may comprise a keypad into which a certain code or codes is or are required to be entered to release the vehicle brake for use of the vehicle. This will prevent unauthorised use of the vehicle. A keypad of this form may also be associated with the control means to enable reprogramming of the control means for example for resetting the parameters of operation including the speed of the vehicle or distance at which the vehicle brakes are applied after release of the vehicle handle.

The braking apparatus of the present invention may be applied to existing hand-propelled vehicles or may be incorporated during construction of hand-propelled vehicles

The present invention thus provides in a further preferred aspect a hand-propelled vehicle of the type having a plurality of supporting wheels and a handle for propelling said vehicle, said vehicle including braking apparatus, said braking apparatus being adapted to prevent or stop movement of said vehicle upon a predetermined movement or velocity of said vehicle subsequent to release of said handle by a user.

Suitably, the handle includes touch sensitive means for sensing grip or touch on the handle or release of the handle. Preferably, wheel rotation sensing means are provided to sense vehicle speed or distance however other means may be provided to sense vehicle speed or distance. Suitably, programmable control means are associated with the touch sensing means and wheel rotation sensing means to control application of a brake to a vehicle wheel to stop movement of the vehicle. Remote control means may alternatively or additionally be provided for actuating the braking apparatus to prevent vehicle movement or for releasing the brig apparatus to permit vehicle movement.

### BRIEF DESCRIPTION OF THE DRAWINGS

In order that the invention may be more readily understood and put into practical effect, reference will now be made to the accompanying drawings which illustrate a preferred embodiment of the invention and wherein;

FIG. 1 illustrates a typical hand-propelled vehicle incorporating braking apparatus according to an embodiment of the invention;

FIG. 2 illustrates schematically the braking apparatus for use with the vehicle of FIG. 1;

FIGS. 3 and 4 illustrate schematically alternative brake configurations for a wheel of the vehicle; and

FIG. 5 illustrates schematically, braking apparatus for application to an existing vehicle.

### DETAILED DESCRIPTION OF THE PREFERRED EMBODIMENT

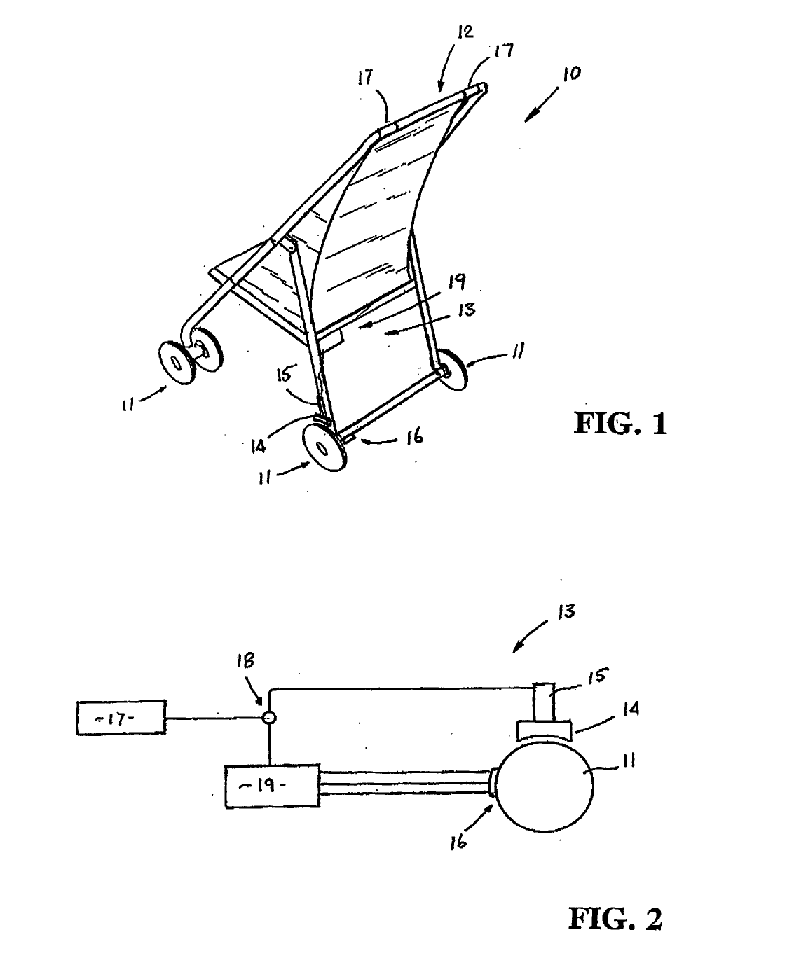

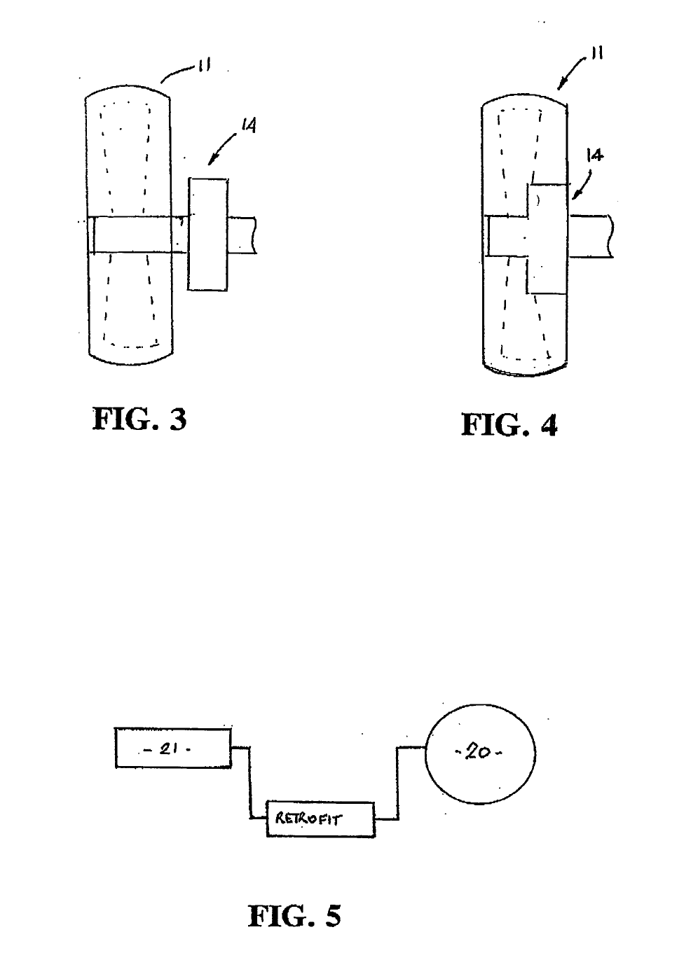

Referring to the drawings and firstly to FIG. 1, there is illustrated a hand-propelled vehicle 10 in this case in the form of a pram or stroller having a plurality of sets of supporting wheels 11, in this case four, and a handle 12 which may be gripped by a user for normally propelling and steering the vehicle 10. Arranged on the vehicle 10 is the braking apparatus 13 according to an embodiment of the invention (also shown in FIG. 2) including a braking member 14 such as a brake pad and actuating means 15 therefor for moving the braking member 14 towards and into engagement with a wheel 11 to effect braking thereof. The braking member 14 may engage the wheel 11 directly or a brake disc on or rotatable with the wheel 11. Alternatively, the braking member 14 may comprise a member which can cooperate with the wheel 11 in any suitable manner to prevent rotation thereof. The actuating means 15 for the brake suitably comprises an electrically operated actuating means such as a solenoid. FIG. 3 illustrates one form of brake mechanism in which the braking member 14 is located externally of the wheel 11 and may be actuated by the actuating means 15 to move into engagement with the wheel 11 to prevent its rotation. FIG. 4 illustrates another form of brake mechanism in which the braking member 14 is located internally of the wheel 11 being part of the wheel assembly, the brake member 14 again being actuable table by the actuating means 15 to engage with the wheel 11 to prevent its rotation.

Also associated with the wheel 11 or one of the other wheels 11 is a rotation sensing means 16 for sensing actual rotation of the wheel 11 or acceleration or velocity of the wheel 11. The sensing means 16 may for example be photoelectric sensing means which can sense rotation of spokes of a wheel by the spokes intercepting a light beam from a light source. Alternatively, the sensing means 16 may use magnetic means for sensing rotation. In yet an alternative arrangement, the sensing means 16 may comprise a mechanical device rotatable with the wheel 11 to provide an output proportional to wheel rotation or speed. In the embodiment of FIG. 3, the sensing means 16 may be arranged externally of the wheel 11 whilst in the embodiment of FIG. 4, the sensing means 16 may be arranged internally of the wheel 11. Different combinations of sensing means 16 and brake configurations however may be employed. The sensing means 16 provides an output in the form of an electrical signal or from which an electrical signal may be derived which is proportional to wheel rotation or rate of wheel rotation.

Mounted on or incorporated in the handle 12 of the vehicle 10 is a touch or grip sensing pad or pads 17 which sense touch or grip of the handle 12. The touch or grip pads 17 are associated with a switch 18 and causes operation of the switch 18 between an on and off state in response to the touch or grip pads 17 sensing touch or grip of the handle 12 or release of touch or grip. The touch or grip pads 17 may operate independently that is the switch 18 will be actuated when either pad 17 is touched or gripped or alternatively, the touch or grip pads 17 may be arranged such that both are required to be gripped or touched at the same time by both hands of the user to cause actuation of the switch 18

A signal processing and control unit 19, typically a programmable microprocessor, is connected to the wheel rotation sensing means 16 and touch pad or pads 17 so as to process signals therefrom. The microprocessor 16 is arranged to control the application of the braking member 14 to the wheel 11 of the vehicle 10 in accordance with information derived from the touch pad 17 and the wheel rotation sensing means 16. For this purpose, the processing unit 19 controls operation of the switch 18 to control application of power to the actuating means 15 for the braking member 14.

The processing unit 19 in one configuration is programmed such that when it senses from the sensing means 16 speed of rotation of the wheel 11 and thus velocity of the vehicle 11 at or beyond a certain value and also senses from the touch pad or pads 17 that the handle 12 of the vehicle 11 is not being grasped or touched, it will switch the switch 18 to supply power to the brake member actuating device 15 to cause the brake member 14 to be applied to the wheel 11 and therefore stop movement of the vehicle 10.

In an alternative arrangement the processing unit 19 is programmed to calculate from the signal derived by the wheel rotation sensing means 16, the number of wheel rotations or the distance which the vehicle moves which is proportional to wheel rotation. In this arrangement, the processing unit 19 causes switching of the switch 18 upon sensing from the touch pad or pads 17 that the handle 12 of the vehicle 11 is not being grasped or touched and upon movement of the vehicle 10 a predetermined distance after sensing from the touch pad or pads 17 that the handle 12 of the vehicle 10 has been released by the user.

The switch 18 is also directly responsive to the touch pad or pads 17 such that when the handle 13 of the vehicle 11 is touched or grasped, the switch 18 is switched to a state preventing power supply to the brake actuating device 15. Thus the brake will not be applied when the handle 13 is grasped and the vehicle is being propelled normally.

Thus when applied to a pram or stroller 10, if the pram or stroller is on an inclined surface and the handle 12 thereof is released resulting in rolling of the pram nor stroller 10 down the inclined surface, the processing unit 19 of the braking apparatus 13 will cause the braking member 15 to be applied automatically upon the velocity of the pram or stroller 10 reaching a predetermined value or the pram or stroller 10 rolling a predetermined distance. The processing unit 19 may also react to either occurrence such as to cause the braking member 14 to be applied when either the pram or stroller moves a predetermined distance or reaches a predetermined velocity after release of the handle 12.

The switch 18 may comprise a switch circuit which progressively increases current supply to the brake actuating device 15 thereby ensuring gradual application of the brake member 14 rather than a sudden application of the brake member 14 which may cause vehicle instability or vehicle capsize. Alternatively, the switch circuit when actuated may apply a boosted supply to the brake actuating device 15 such as by use of an additional voltage from the power supply or capacitor discharge. Whilst the apparatus is particularly suited for incorporation in a hand-propelled vehicle during construction thereof, it may also be retrofitted to existing vehicles as shown schematically in FIG. 3. In this situation, the vehicle is retrofitted with a suitable brake and actuator therefor, wheel rotation sensing means and a touch pad or pads 20. These components are connected with a central processing or control unit 21 as described above such that the braking apparatus will function in the manner previously described.

The braking mechanism for the wheel or wheels 11 of the vehicle 10 may of course be in many different configurations of many different types. For example, the braking mechanism may comprise an electrically operated brake as described, a torsion spring brake, disc or drum brakes, clutch brakes for example incorporating a spring clutch, a hydraulic or pneumatic coupling, an inertia or reverse inertia brake, or a magnetic brake or a friction brake (other than a disc or drum brake). Preferably also means may be provided to enable resetting or releasing of the brake after its operation so as to be ready for subsequent operation. The resetting means may be provided on the vehicle handle or provided on the brake mechanism or control unit.

The vehicle may also include a lanyard which is coupled to the vehicle and which may be connected to the user for example by a wrist band. The lanyard at the vehicle may be coupled to a “kill” switch or a “kill” switch may be incorporated in the lanyard which is actuated to apply the brake to the vehicle if the vehicle is moved away from the user to an extent to detach the lanyard from the vehicle or break the lanyard and thus cause switching of the kill switch. Switching of the kill switch causes operation of the brake activation device 15 to apply the braking member 14 to the vehicle wheel 11. A system which uses a lanyard as above does not require the use of touch pads or switches 17 but simply causes the a brake to be applied to the vehicle if the vehicle moves a certain distance from the user.

The braking apparatus of the invention is particularly suited for use with strollers or prams carrying infants for safety purposes to prevent inadvertent rolling of the pram or stroller or even possible abduction. The apparatus of the invention however may be applied to other hand-propelled vehicles such as shopping trolleys or trolleys used in commercial applications. A further means for actuating or deactivating the braking mechanism may be by way of a remote control hand held unit.

Whilst the above has been given by way of illustrative embodiment of the invention, all such variations and modifications thereto as would be apparent to persons skilled in the art are deemed to fall within the broad scope and ambit of the invention as herein defined in the appended claims.

1-23. (canceled)

24. Braking apparatus for use with a hand propelled vehicle having a handle by which said vehicle is propelled by hand and braking means for braking said vehicle, said apparatus including means for sensing touch of, or grip of, portion of said handle by a user propelling said vehicle, and control means associated with said touch or grip sensing means for preventing or stopping movement of said vehicle by actuation of said braking means after or upon a predetermined movement of said vehicle subsequent to release of handle of said vehicle by said user as sensed by said touch or grip sensing means.

25. Braking apparatus as claimed in claim 24 wherein said touch or grip sensing means comprises one or more touch sensitive switches.

26. Braking apparatus as claimed in claim 25 wherein said touch sensitive switch or switches comprise a touch pad or pads on or in the handle.

27. Braking apparatus as claimed claim 24 wherein said vehicle includes a plurality of wheels and wherein said braking means comprises a selectively actuable brake assembly associated with one or more of said wheels and wherein said control means prevents or stops movement of the vehicle by actuation of said selectively actuable brake assembly.

28. Braking apparatus as claimed in claim 27 wherein said brake assembly comprises a brake activation device and a braking member which is movable by the activation device into engagement with a vehicle wheel to prevent or stop rotation thereof.

29. Braking apparatus as claimed in claim 28 wherein said brake activation device is selectively actuable to release the braking member from the wheel to allow its rotation.

30. Braking apparatus as claimed in claim 28 wherein said activation device is single acting and associated with a mechanical member which applies a braking force to, or releases a braking force from the braking member, in accordance with the state of activation of the brake activation device.

31. Braking apparatus according to claim 28 wherein said brake activation device comprises an electrically operated activation device and wherein the control means is arranged to control the supply of power to the brake activation device to control activation thereof.

32. Braking apparatus as claimed in claim 31 wherein said control means includes a switch through which power is supplied to said brake activation device, said switch being associated with the touch or grip sensing means, said control means preventing operation of said switch and thus preventing supply of power to said brake activation device when the touch or grip sensitive means sense touch or grip of the portion of the handle of the vehicle by a user.

33. Braking apparatus as claimed in claim 24 wherein said touch or grip sensing means comprises a pair of grip or touch sensitive pads or switches which are spaced apart on the handle of the vehicle.

34. Braking apparatus as claimed in claim 33 wherein both said pads or switches are required to be activated by touch or grip by both hands of a user to prevent braking of said vehicle by said braking means.

35. Braking apparatus according to claim 24 and including movement sensing means associated with said vehicle for sensing the velocity of movement of the vehicle and/or directly or indirectly, the distance moved by the vehicle.

36. Braking apparatus as claimed in claim 35 wherein said control means is associated with the movement sensing means whereby the control means can determine when to prevent or stop movement of the vehicle.

37. Braking apparatus as claimed in claim 36 wherein said touch sensitive pads or switches comprise a keypad into which a predetermined code or codes is or are required to be entered to release the braking means for use of the vehicle.

38. A hand propelled vehicle having a plurality of supporting wheels and a handle for propelling said vehicle and braking apparatus for braking movement of said vehicle, said braking apparatus being adapted to prevent or stop movement of said vehicle upon a predetermined movement or velocity of said vehicle subsequent to release of said handle by a user.

39. A vehicle as claimed in claim 38 wherein said handle includes touch sensitive means for sensing grip or touch on the handle or release of the handle by said user.

40. A vehicle as claimed in claim 42 and including wheel rotation sensing means for sensing wheel rotation to sense vehicle speed or distance.

41. A vehicle as claimed in claim 43 including programmable control means associated with the touch sensing means and wheel rotation sensing means to control application of a brake to a vehicle wheel to stop movement of the vehicle.

42. A vehicle having a plurality of supporting wheels, braking apparatus for braking movement of said vehicle by braking one or more of said wheels, control means for sensing when a user of said vehicle no longer has control of said vehicle, said control means being further adapted to actuate said braking apparatus to prevent or stop movement of said vehicle upon a predetermined movement or velocity of said vehicle subsequent to release of control of said vehicle by said user.

43. A vehicle as claimed in claim 42 wherein said control means includes touch or pressure sensitive means responsive to said user for sensing that the user has or no longer has control of said vehicle.
